(19) United States
(12) Patent Application Publication
(10) Pub. No.: US 2014/0175332 A1
(43) Pub. Date: Jun. 26, 2014

(54) Recycling of Natural and Synthetic Rubbers

(71) Applicant: Elastomer Technologies LTD, St. Helier (GB)

(72) Inventor: Tan Sri Dr. Balachandra Chakkinggal Sekhar, Selangor (MY)

(73) Assignee: Elastomer Technologies LTD, St. Helier (GB)

(21) Appl. No.: 14/195,477

(22) Filed: Mar. 3, 2014

Related U.S. Application Data
(63) Continuation of application No. 12/373,455, filed on Apr. 14, 2010, now abandoned.

(30) Foreign Application Priority Data
Jul. 13, 2006 (MY) PI20063358

(51) Int. Cl. C08J 11/28

(52) U.S. Cl. CPC C08J 11/28
USPC 252/182.17; 252/182.14

(57) ABSTRACT

A delinking composition in the form of a combined solid dose comprising:
(i) one or more elastomer delinking accelerators selected from the group consisting of zinc salts of thiocarbamates and zinc salts of dialkyl dithiophosphates; and
(ii) one or more elastomer delinking accelerators selected from the group consisting of 2-mercaptobenzothiazole or derivatives thereof, thiurams, guanidines, 4,4′-dithiomorpholine and sulpenamides; and
(iii) at least one elastomer delinking activator.

### FIELD OF INVENTION

The invention relates to the devulcanisation of elastomeric articles such as tyres, mouldings, gloves and belts made from natural rubber or synthetic rubber or blends thereof which have been vulcanised. More particularly, the invention relates to compositions which aid in the devulcanisation of vulcanised elastomeric materials and to devulcanisation processes for treating vulcanised elastomeric materials with said compositions so that the devulcanised elastomers can be recycled.

### BACKGROUND

Recycling of rubber from used rubber articles is well known in the industry where some 200,000 tonnes of used rubber is recycled per annum. Conventional devulcanisation processes (for example, the Reclaimator process and the Lancaster-Banbury method) use high temperatures and catalysts to digest the elastomeric material resulting in a high consumption of energy and appreciable degradation of the elastomeric material being devulcanised. The devulcanised elastomers from these processes typically displays poor physical properties and accordingly the reuse of these elastomers is limited. For instance, a typical devulcanised rubber has tensile strength not more than 5 to 6 Mpa while raw natural rubber with the same compound can provide strengths of over 20 Mpa.

The conventional rubber devulcanisation processes in essence consist of taking vulcanised rubber crumbs, admixing them with catalysts and subjecting the admixture to temperatures of more than 170° C. for periods of more than 4 to 6 hours in a digestor. The resulting material is then subjected to mastication until it is rendered into sheet form. The resultant rubber material is typically reused (recycled) in small proportions as processing aids (“reclaim rubber”) or diluents with fresh rubber compounds. However, the presence of poor quality rubber in such mixtures adversely affects the physical and dynamic properties of the final vulcanisate.

Because of the reluctance of operators to increase proportions of reclaim rubber as processing aids, used tyres and other elastomeric articles are becoming an environmental hazard globally. There is a distinct demand for a satisfactory recycling process or to improve upon current processes to address this ever increasing environmental problem. The used tyre mountains now in existence globally are a fire hazard. Besides trying to devulcanise used rubber by the processes mentioned above, many other approaches have been made to address this environmental issue. Among these include the use of pelletized tyre crumbs for road surfacing, the burning of such crumbs to generate energy and so on.

None of the conventional methods or approaches have succeeded in making any real progress in solving this vexing global problem.

### SUMMARY OF THE INVENTION

The present invention relates to a method of effectively recycling vulcanised elastomeric materials by providing a cost effective devulcanisation process which opens up or “delinks” the crosslinks of the vulcanized network structure in used vulcanised elastomers without unduly degrading the backbone polymer. The efficiency of this process is typically measured by how close (in the physical properties) the devulcanised (delinked) elastomer is to the original physical and dynamic characteristics of the original natural or synthetic elastomer. The closer the devulcanised elastomer is to the original elastomer the wider the applicability of the devulcanised elastomer in further manufacturing processes.

In one aspect the present invention provides a delinking composition in the form of a combined solid dose comprising:
(i) one or more elastomer delinking accelerators selected from the group consisting of zinc salts of thiocarbamates and zinc salts of dialkyl dithiophosphates; and
(ii) one or more elastomer delinking accelerators selected from the group consisting of 2-mercaptobenzothiazole or derivatives thereof, thiurams, guanidines, 4,4′-dithiomorpholine and sulpenamides; and
(iii) at least one elastomer delinking activator.

In a further aspect the present invention provides a process for devulcanising a vulcanised elastomeric material, wherein the process comprises treating the vulcanised elastomeric material with a delinking composition in the form of a combined solid dose comprising:
(i) one or more elastomer delinking accelerators selected from the group consisting of zinc salts of thiocarbamates and zinc salts of dialkyl dithiophosphates; and
(ii) one or more elastomer delinking accelerators selected from the group consisting of 2-mercaptobenzothiazole or derivatives thereof, thiurams, guanidines, 4,4′-dithiomorpholine and sulpenamides; and
(iii) at least one elastomer delinking activator,
   for a time and under conditions sufficient to open up or delink the vulcanised elastomeric material thereby providing a curable devulcanised elastomeric material.

### DETAILED DESCRIPTION OF THE INVENTION

The composition of the present invention comprises chemical compounds which are capable of performing an elastomer accelerator function together with one or more activators. The elastomer accelerators, when used together with one or more activators, are capable of initiating proton exchange and therefore have the capabilities of opening up or “delinking” the vulcanised network of a cured elastomeric material to provide a curable devulcanised elastomeric material which can be recycled.

The term “elastomer” or “elastomeric material” refers not only to synthetic thermosetting high polymers but also includes natural rubber. It would be appreciated that an elastomeric material has the ability to be stretched to at least twice its original length and to retract very rapidly to approximately its original length when released. Apart from natural rubber some other elastomeric materials include styrene-butadiene copolymer, polychloroprene (neoprene), nitrile rubber, butyl rubber, polysulfide rubber (“Thiolcol”), cis-1,4-polyisoprene, ethylene-propylene terpolymers (EPDM rubber), silicone rubber and polyurethane rubber. These elastomeric materials can be cross-linked or cured with sulfur to form vulcanised elastomeric materials.

The present invention is particularly directed to the recycling of sulphur-cured (vulcanised) elastomeric materials after being subjected to a devulcanising process and more preferably sulphur-cured natural rubber, butyl rubber and other sulphur-cured expensive synthetic elastomers. Most preferably the present invention is directed to the devulcanisation of sulphur-cured natural rubber for the purposes of being able to effectively recycle the devulcanised natural rubber.

In relation to the delinking composition of the present invention, preferred accelerators are compound mixtures which include zinc salts of thiocarbamates, and preferably zinc dimethyldithiocarbamate (hereinafter “ZDMC”) together with 2-mercaptobenzothiazole (hereinafter “MBT”), or derivatives thereof.

When used together it is preferred that the amount of ZDMC to MBT (or derivatives thereof) is in the molar ratio range of 1:1 to 1:12.

ZDMC and MBT being mentioned above as preferred accelerators may be replaced with other accelerators some of which may be less active. The following, which are no means exhaustive, are examples of known accelerators which may replace ZDMC and MBT.

ZDMC may be replaced on a molecular basis by other zinc salts of dithiocarbamates such as zinc diethyldithiocarbamate (ZDEC), zinc dipropyldithiocarbamate, zinc dibutylthiocarbamate (ZBDC) or zinc dibenzyldithiocarbamate (ZBEC), or by zinc dialkyl dithiophosphates such as zinc dibutyldithiophosphate.

Similarly, MBT may be replaced on a molecular basis by other thiazole accelerators such as benzothiazyl disulphide (MBTS), or zinc 2-mercaptobenzothiazole (ZMBT), or by sulphenamide accelerators such as N-cyclhexyl-2-benzothiazole sulphenamide (CBS) or N-tert-butyl 2-benzothiazole sulphenamide (TBBS), or by thiuram accelerators such as tetraethylthiuram disulphide (IFID), tetramethylthiuram disulphide (TMTD) or tetrabenzylthiuram disulphide (TBETD), or by nitrogen-based accelerators such as guanidines, N,N′-diphenylguanidine, d-ortho-tolylguanidine, and 4,4′-dithiomorpholine.

The combination of MBT (or derivatives of MBT) or other accelerators and ZDMC (or derivatives of ZDMC) initiates the proton exchange reaction through the assistance of delinking activators such as stearic acid, zinc oxide, and methacrylic acid. Preferably, the accelerators are activated by zinc oxide alone, or more preferably a mixture of steric acid and zinc oxide may be used as an activator in combination.

The delinking composition of the present invention is produced and used in the form of a combined solid dose. The term “combined solid dose” means that the components of the composition are presented in combination in a compacted solid form such that the accelerator and activator components are maintained in close proximity to each other. Preferably, the combined solid dose is a pellet, tablet, briquette or granule. Most preferably the combined solid dose is a pellet or tablet and even more preferably a pellet.

Pellets and tablets of the composition may be formed by conventional pelletisation or tableting processes which are used in, for instance, the pharmaceutical or agrochemical industry. It would be evident to the skilled person that the actual shape of the combined solid dose is not an important parameter, and that any obtainable shape is within the scope of the present invention.

Pellets of the present invention may be formed, for instance, by wet or dry granulation methods, direct compression or by simple extrusion processes using conventional pellet mills which operate, for instance, on the ring-roll principle.

In this latter system the pellet mill has a cylindrical ring or die having apertures spaced uniformly and drilled radially. Extrusion is accomplished by rollers acting on the inner face of the die which apply enough force to effect agglomeration of the compositional components and force the agglomerate through the apertures. As the agglomerate is extruded from the die, slicing means (eg fixed knives) control the length of the resulting pellets.

To aid in the pelletizing/tableting process the components of the composition may further comprise additives or excipients such as water or binders such as starch, gelatin or gum arabica.

For instance, a typical pelletizing process may involve thoroughly mixing the components in a mixer, wetting the mixture with sufficient water to form an agglomerate, extruding, cutting into pellets, drying the pellets and then bagging the pellets for storage or transport.

If further additives are to be included in the composition of the present invention they are preferably added in a total amount which is less than 10% by weight of the total delinking composition. More preferably, the total amount of any further additives in the composition is less than 5% by weight.

Most preferably however, the composition of the present invention, in the form of a combined solid dose, contains exclusively:
(i) one or more elastomer delinking accelerators selected from the group consisting of zinc salts of thiocarbamates and zinc salts of dialkyl dithiophosphates; and
(ii) one or more elastomer delinking accelerators selected from the group consisting of 2-mercaptobenzothiazole or derivatives thereof, thiurams, guanidines, 4,4′-dithiomorpholine and sulpenamides; and
(iii) at least one elastomer delinking activator.

That is, in the most preferred embodiment, the combined solid dose of the present delinking composition does not include any further additives. One of the benefits of this is that the delinking compositions of the present invention do not contain the known hazardous delinking agent, hexamethylene tetramine.

The main advantages of the composition of the present invention are directly related to the compositions being in the form of a combined solid dose. In the past devulcanisation processes which use delinking accelerators/activators generally included dispersing agents, particularly diethylene glycol or triethylene glycol. The dispersing agents are included as a result of the density differences of the active ingredients which tend to segregate in bulk, especially for instance, zinc oxide which is of high density. This is thought to lead to inefficient activation of the accelerators. To inhibit segregation, glycols (and other diols) have been used to bind the ingredients. For example, U.S. Pat. No. 5,770,632 discloses a delinking composition comprising MBT, ZDMC, stearic acid, zinc oxide, sulphur and diethylene glycol in the form of a paste. It is stated that the glycol is added to aid in the dispersion of the powdered components and suggests that it may also further activate the mixture.

The present inventors have identified that a problem with this prior art system is that the introduction of the glycol not only increases production costs but also causes the vulcanised elastomer/delinking mixture to absorb significant amounts of moisture which is undesirable. The presence of water through moisture absorption and sweating of the delink composition renders further processing inefficient and passage through the mill rollers slippery.

The present invention overcomes this segregation problem because the accelerator/activator components are combined in a solid form which means that the activators/accelerators remain proximal to each other which allows for effective delinking. Also, the absence of glycol dispersants means that the delinking composition is not prone to absorb significant amounts of moisture.

Also described in U.S. Pat. No. 5,770,632 is a method of devulcanising rubber with a delinking composition in a masterbatch process. Masterbatching is typically used in the industry to uniformly disperse small amounts of reagents. In this masterbatch process the delinking composition is first mixed with fresh rubber, the ratios of delinking composition to rubber varying between 90:10 to 40:60. The masterbatch is then mixed with vulcanised rubber crumbs in proportions which will ensure that the ultimate ratio of delinking composition to vulcanised rubber is 6:100 parts by weight. The ultimate mixture undergoes mastication where the mill temperature is not allowed to exceed 70° C. The temperature is regulated by circulating cooling water through the rollers of the mill.

As stated above the present inventors have overcome the dispersion problems of the prior art processes by formulating the delinking compositions into a combined solid dose (e.g. pellets). Another advantage of having the composition in the form of a combined solid dose relates to the ease of dispersing the delinking composition which effectively eliminates the need for masterbatching.

There is also a further advantage of presenting the delinking composition in the form of a combined solid dose. As it is not necessary to dilute the active ingredients with added dispersants, the amount of delinking composition required for the devulcanisation process can be drastically reduced. For instance, the process described in U.S. Pat. No. 5,770,632 requires a ratio of delinking composition to rubber of 6:100 parts by weight. In contrast, the delinking composition in the form of pellets allows for the devulcanisation process to proceed effectively with 1 to 2 parts of the delinking composition per 100 parts of vulcanised rubber crumbs.

Furthermore, the combined solid dose is effective in delinking rubber at the high temperatures, pressures and shear which are applied during Lancaster-Banbury devulcanising processes.

Accordingly, in a further aspect the invention provides a process for devulcanising a vulcanised elastomeric material, wherein the process comprises treating the vulcanised elastomeric material with a delinking composition in the form of a combined solid dose comprising:
(i) one or more elastomer delinking accelerators selected from the group consisting of zinc salts of thiocarbamates and zinc salts of dialkyl dithiophosphates; and
(ii) one or more elastomer delinking accelerators selected from the group consisting of 2-mercaptobenzothiazole or derivatives thereof, thiurams, guanidines, 4,4′-dithiomorpholine and sulpenamides; and
(iii) at least one elastomer delinking activator,
   for a time and under conditions sufficient to open up or delink the vulcanised elastomeric material thereby providing a curable devulcanised elastomeric material.

Preferably, the temperature of the process is kept at between 90 to 105° C. The advantage of this over the prior (for instance, U.S. Pat. No. 5,770,632) is evident as it eliminates the added economic and engineering burden associated with maintaining the mill at temperatures below 70° C.

The process using the delinking agents in pellet form can be used with any natural or synthetic elastomer which is sulphur cured. In the earlier process of masterbatching (for instance U.S. Pat. No. 5,770,632), the rubber used to incorporate the delinking chemicals had to be changed for each type of vulcanised elastomer. With the use of the combined solid dose and in particular pellets, this incompatibility problem does not arise.

In a preferred embodiment, the process involves the devulcanisation of vulcanised used elastomer crumbs or dust from sulphur vulcanisation. These crumbs are admixed with the delink pellets of the present invention in the proportion of 1.5 to 2 parts per 100 parts of crumb, in a high shear mill or intermix. The temperature in the mill or intermix preferably does not exceed 90-95° C. The time of mixing is controlled to preferably not exceed more than 5 to 6 minutes and if the temperature rises to over 90° C., the lid of the intermix is opened and then closed thereby reducing the temperature.

The devulcanised elastomeric material from the present process may be reused (recycled) by a subsequent fabricating, moulding and/or vulcanisation process to produce an article. Typical articles which may be prepared from the devulcanised elastomeric materials include tyres, car mats, carpet underlays, electrical insulation parts or layers, industrial tyres, tubing and retreads.

The present invention, while providing a more effective devulcanisation and hence recycling process, does not contemplate the reuse of the devulcanised products at 100% level, but depending on products, appropriate fresh rubber compounds are mixed with the devulcanised material at concentrations of around 10% to 30%. However, 100% of the devulcanised material may be used in low end applications.

Those skilled in the art will appreciate that the invention described herein in susceptible to variations and modifications other than those specifically described. It is to be understood that the invention includes all such variations and modifications which fall within the spirit and scope. The invention also includes all of the steps, features, compositions and compounds referred to or indicated in this specification, individually or collectively, and any and all combinations of any two or more of said steps or features.

Certain embodiments of the invention will now be described with reference to the following examples which are intended for the purpose of illustration only and are not intended to limit the scope of the generality hereinbefore described.

### EXAMPLES

### Example 1

40 mesh tyre dust was intermixed with delink pellets in the ratio of 100 parts dust to 2 parts pellets. A small amount of plasticiser is added at the tail end to control compound viscosity. The devulcanised material is dumped onto a roll mill. This material is then mixed with freshly made tyre tread compounds at different proportions as indicated in Table 1.

TABLE 1
MOONEY VISCOSITY AND CURE CHARACTERISTICS OF THE
COMPOUNDS

| | 40 Mesh Tyre Dust | | | | Butyl | | | |
|---|---|---|---|---|---|---|---|---|
| | Tyre treads/devulc ratio | | | | Inner tube/devulc ratio | | | |
| | 100:0 | 90:10 | 80:20 | 0:100 | 100:0 | 90:10 | 80:20 | 0:100 |
| Properties | | | | | | | | |
| Mooney viscosity, 100° C. | 70.6 | 57.5 | 66.2 | — | 69.2 | 72.1 | 78.4 | — |
| Mooney scorch, 120° C. | 27.7 | 18.7 | 13.6 | 2.1 | 24.1 | 24.8 | 20.5 | 6.1 |
| min | | | | | | | | |
| Rheometer MDR 2000, | | | | | | | | |
| 150° C., arc 0.5 | | | | | | | | |
| M_{HR}, in.lb | 17.4 | 17.6 | 17.2 | 16.2 | 12.5 | 12.5 | 12.3 | 9.8 |
| M_{L}, in.lb | 3.3 | 2.8 | 3.3 | 6.2 | 2.3 | 2.6 | 2.8 | 4.8 |
| M_{HR} − M_{L}, in.lb | 14.1 | 14.8 | 13.9 | 10.0 | 10.2 | 9.9 | 9.5 | 5.0 |
| Scorch time, tₛ₂, min | 3.6 | 2.5 | 2.0 | 0.3 | 3.9 | 3.7 | 3.5 | 3.0 |
| Cure t_{c90}, min | 5.8 | 4.0 | 3.2 | 3.5 | 20.7 | 20.5 | 19.8 | 20.3 |
| Cure rate, t_{c90} − tₛ₂, min | 2.2 | 1.5 | 1.2 | 3.3 | 16.8 | 16.8 | 16.3 | 17.3 |
| Cure t_{c95}, min | 7.3 | 4.5 | 3.6 | 4.9 | 24.7 | 24.7 | 24.2 | 24.6 |
| Cure time at 150° C., min | 8 | 5 | 5 | 5 | 25 | 25 | 25 | 25 |
| Tensile Properties | | | | | | | | |
| M100%, MPa | 2.9 | 2.8 | 2.7 | 3.1 | 2.6 | 2.2 | 2.2 | 2.0 |
| M300%, MPa | 12.4 | 12.6 | 12.3 | — | 7.1 | 6.5 | 6.4 | 7.4 |
| EB, % | 500 | 420 | 410 | 250 | 520 | 580 | 530 | 380 |
| TS, MPa | 24.4 | 20.3 | 19.7 | 13.9 | 13.6 | 14.1 | 14.1 | 10.5 |
| Hardness, IRHD | 69.5 | 70.1 | 70.3 | 68.8 | 61.8 | 61.8 | 61.4 | 60.1 |
| Tear, crescent, N/mm | 101 | 100 | 91 | 24 | 37 | 41 | 35 | 20 |
| Comp. Set, %, 1 day | 27.2 | 33.7 | 32.8 | 21.0 | 20.4 | 22.6 | 25.3 | 30.0 |
| @ 70° C. | | | | | | | | |
| Resilience, Lupke, % | 47 | 45 | 47 | 59 | 13 | 12 | 12 | 13 |
| Dunlop, % | 60 | 59 | 60 | 72 | 48 | 52 | 49 | 52 |
| Abrasion, DIN, mm³ | 162 | 163 | 174 | 206 | 445 | 451 | 493 | 522 |
| , ARI, % | 101 | 100 | 94 | 79 | 37 | 36 | 33 | 31 |
| HBU, (0.125 in, 24 lb, | 19.8 | 17.8 | 21.8 | 14.3 | 16.8 | 14.4 | 15.8 | 13.9 |
| 100° C.), Temp rise, ° C. | | | | | | | | |

TABLE 2
Formulations of *NR gum mix - white Devulc Crepe blends

| | Mix Number | | | | |
|---|---|---|---|---|---|
| | A | B | C | D | E |
| NR gum mix | 100 | 80 | 50 | 30 | 0 |
| Devulc Crepe | 0 | 20 | 50 | 70 | 100 |
| M_{L} (1 + 4) 100° C. | 21 | 21.7 | 33.4 | 45.1 | 57.4 |
| t₉₅ @ 140° C. (min) | 27 | 5 | 6 | 7 | 35 |
| Tensile Properties | | | | | |
| M100 (MPa) | 1.02 | 1.25 | 1.04 | 0.94 | 0.63 |
| M300 (MPa) | 2.54 | 3.77 | 2.84 | 2.47 | 1.40 |
| TS (MPa) | 27.89 | 29.47 | 27.96 | 28.48 | 18.01 |
| EB (%) | 590 | 523 | 608 | 639 | 790 |

*Gum Mix Formulations: NR 100, Zinc oxide 5, Stearic acid 2, Flectol H 2, Sulphur 2.5, MOR 0.5

TABLE 3
Formulations of *tread mix -black Devulc Crepe blends

| Mix Number | A | B | C | D | E | F |
|---|---|---|---|---|---|---|
| NR/BR tread | 100 | 80 | 50 | 30 | 10 | 0 |
| mix | | | | | | |
| Devulc Crepe | 0 | 20 | 50 | 70 | 90 | 100 |
| M_{L} (1 + 4) | 42 | 39.3 | 52 | 73.8 | 98.2 | 106.4 |
| 100° C. | | | | | | |
| t₉₅ @ 140° C. | 38 | 19 | 18 | 20 | 30 | 50 |
| (min) | | | | | | |
| Tensile | | | | | | |
| Properties | | | | | | |
| M100 (MPa) | 2.59 | 2.54 | 2.44 | 2.46 | 2.49 | 2.19 |
| M300 (MPa) | 11.83 | 11.99 | 11.47 | 11.6 | 11.83 | 10.15 |
| TS (MPa) | 24.89 | 20.21 | 16.87 | 16.12 | 14.64 | 11.40 |
| EB (%) | 521 | 434 | 397 | 370 | 345 | 321 |

*NR/BR tread mix formulations as shown earlier in Table 2 (mix A)

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps.

The reference in this specification to any prior publication (or information derived from it), or to any matter which is known, is not, and should not be taken as an acknowledgment or admission or any form of suggestion that that prior publication (or information derived from it) or known matter forms part of the common general knowledge in the field of endeavour to which this specification relates.

1. A delinking composition comprising:
(i) one or more elastomer delinking accelerators selected from the group consisting of zinc salts of thiocarbamates and zinc salts of dialkyl dithiophosphates; and
(ii) one or more elastomer delinking accelerators selected from the group consisting of 2-mercaptobenzothiazole or derivatives thereof, thiurams, guanidines, 4,4′-dithiomorpholine and sulphenamides; and
(iii) at least one elastomer delinking activator,
wherein the delinking composition is in the form of a combined solid dose devoid of dispersing agents and binders.

2. A delinking composition according to claim 1, wherein the elastomer accelerators are selected from the following:
(i) zinc dimethyldithiocarbamate, zinc diethyldithiocarbamate, zinc dipropyldithiocarbamate, zinc dibutyldithiocarbamate and zinc dibenzyldithiocarbamate; and
(ii) 2-mercaptobenzothiazole, zinc mercaptobenzothiazole and benzothiazyl disulphide, N-cyclohexyl-2-benzothiazolesulphenamide and N-tert-butyl-2-benzothiazole sulphenamide; tetraethylthiuram disulphide, tetramethylthiuram disulphide, and tetrabenzylthiuram disulphide guanidines, N,N′-diphenylguanidine, diorthotolylguanidine and 4,4′-dithiomorpholine.

3. A delinking composition according to claim 2, wherein the elastomer accelerators are selected from the following:
(i) zinc dimethyldithiocarbamate, zinc diethyldithiocarbamate, zinc dipropyldithiocarbamate, zinc dibutyldithiocarbamate and zinc dibenzyldithiocarbamate; and
(ii) 2-mercaptobenzothiazole, zinc mercaptobenzothiazole, and benzothiazyl disulphide.

4. A delinking composition according to claim 1, wherein the elastomer accelerators are zinc dimethyldithiocarbamate (ZDMC) and 2-mercaptobenzothiazole (MBT).

5. A delinking composition according to claim 4, wherein the amount of ZDMC to MBT is in the molar ratio range of about 1:1 to 1:12.

6. A delinking composition according to claim 1, wherein the activator component is a mixture of stearic acid and zinc oxide.

7. A delinking composition according to claim 1, wherein the combined solid dose is pellets.

8. (canceled)

9. A delinking composition according to claim 1, for use in delinking sulphur-cured (vulcanised) rubber.

10. A delinking composition consisting of:
(i) one or more elastomer delinking accelerators selected from the group consisting of zinc salts of thiocarbamates and zinc salts of dialkyl dithiophosphates;
(ii) one or more elastomer delinking accelerators selected from the group consisting of 2-mercaptobenzothiazole or derivatives thereof, thiurams, guanidines, 4,4′-dithiomorpholine and sulphenamides; and
(iii) at least one elastomer delinking activator,
wherein the delinking composition is in the form of a combined solid dose.

11. A delinking composition according to claim 10, wherein the elastomer accelerators are selected from the following:
(i) zinc dimethyldithiocarbamate, zinc diethyldithiocarbamate, zinc dipropyldithiocarbamate, zinc dibutyldithiocarbamate and zinc dibenzyldithiocarbamate; and
(ii) 2-mercaptobenzothiazole, zinc mercaptobenzothiazole and benzothiazyl disulphide, N-cyclohexyl-benzothiazolesulphenamide and N-tert-butyl-2-benzothiazole sulphenamide; tetraethylthiuram disulphide, tetramethylthiuram disulphide, and tetrabenzylthiuram disulphide guanidines, N,N′-diphenylguanidine, diorthotolylguanidine and 4,4′-dithiomorpholine.

12. A delinking composition according to claim 11, wherein the elastomer accelerators are selected from the following:
(i) zinc dimethyldithiocarbamate, zinc diethyldithiocarbamate, zinc dipropyldithiocarbamate, zinc dibutyldithiocarbamate and zinc dibenzyldithiocarbamate; and
(ii) 2-mercaptobenzothiazole, zinc mercaptobenzothiazole, and benzothiazyl disulphide.

13. A delinking composition according to claim 12, wherein the elastomer accelerators are zinc dimethyldithiocarbamate (ZDMC) and 2-mercaptobenzothiazole (MBT).

14. A delinking composition according to claim 13, wherein the amount of ZDMC to MBT is in the molar ratio range of about 1:1 to 1:12.

15. A delinking composition according to claim 11, wherein the activator component is a mixture of stearic acid and zinc oxide.

16. A delinking component according to claim 11, for use in delinking sulphur-cured (vulcanised) rubber.

17-30. (canceled)

31. A delinking composition comprising:
(i) one or more elastomer delinking accelerators selected from the group consisting of zinc salts of thiocarbamates and zinc salts of dialkyl dithiophosphates;
(ii) one or more elastomer delinking accelerators selected from the group consisting of 2-mercaptobenzothiazole or derivatives thereof, thiurams, guanidines, 4,4′-dithiomorpholine and sulphenamides;
(iii) at least one elastomer delinking activator; and
(iv) additives or excipients to aid in the pelletizing process, wherein the total amount of the additives or excipients is less than 5% by weight of the total delinking composition,
wherein the delinking composition is in the form of a combined solid dose.

32. A delinking composition according to claim 31, wherein the elastomer accelerators are selected from the following:
(i) zinc dimethyldithiocarbamate, zinc diethyldithiocarbamate, zinc dipropyldithiocarbamate, zinc dibutyldithiocarbamate and zinc dibenzyldithiocarbamate; and
(ii) 2-mercaptobenzothiazole, zinc mercaptobenzothiazole and benzothiazyl disulphide, N-cyclohexyl-2-benzothiazolesulphenamide and N-tert-butyl-2-benzothiazole sulphenamide; tetraethylthiuram disulphide, tetramethylthiuram disulphide, and tetrabenzylthiuram disulphide guanidines, N,N′-diphenylguanidine, diorthotolylguanidine and 4,4′-dithiomorpholine.

33. A delinking composition according to claim 32, wherein the elastomer accelerators are selected from the following:
(i) zinc dimethyldithiocarbamate, zinc diethyldithiocarbamate, zinc dipropyldithiocarbamate, zinc dibutyldithiocarbamate and zinc dibenzyldithiocarbamate; and
(ii) 2-mercaptobenzothiazole, zinc mercaptobenzothiazole, and benzothiazyl disulphide.

34. A delinking composition according to claim 31, wherein the elastomer accelerators are zinc dimethyldithiocarbamate (ZDMC) and 2-mercaptobenzothiazole (MBT).

35. A delinking composition according to claim 32, wherein the amount of ZDMC to MBT is in the molar ratio range of about 1:1 to 1:12.

36. A delinking composition according to claim 31, wherein the activator component is a mixture of stearic acid and zinc oxide.

37. A delinking composition according to claim 31, wherein the combined solid dose is pellets.

38. A delinking composition according to claim 31, for use in delinking sulphur-cured (vulcanised) rubber.
